(19) United States
(12) Patent Application Publication
(10) Pub. No.: US 2026/0189182 A1
(43) Pub. Date: Jul. 2, 2026

(54) GUIDE RAIL, GUIDE RAIL ASSEMBLY, PHOTOVOLTAIC ASSEMBLY AND METHOD FOR ARRANGING THE PHOTOVOLTAIC ASSEMBLY

(71) Applicants: Li Wang, NINGBO CITY (CN); Liqiang Chen, NINGBO CITY (CN); Xinwei Mo, NINGBO CITY (CN); Xiaojuan Zhou, NINGBO CITY (CN); Fang Hou, NINGBO CITY (CN)

(72) Inventors: Li Wang, NINGBO CITY (CN); Liqiang Chen, NINGBO CITY (CN); Xinwei Mo, NINGBO CITY (CN); Xiaojuan Zhou, NINGBO CITY (CN); Fang Hou, NINGBO CITY (CN)

(73) Assignee: NINGBO VOLTAGE SMART PRODUCTION CO., LTD, NINGBO CITY (CN)

(21) Appl. No.: 19/406,031

(22) Filed: Dec. 2, 2025

(30) Foreign Application Priority Data
Dec. 31, 2024 (CN) 20241196365.4
Dec. 31, 2024 (CN) 202411996365.4

(51) Int. Cl. H02S 30/20

(52) U.S. Cl. CPC H02S 30/20

(57) ABSTRACT

The present application relates to a guide rail, a guide rail assembly, a photovoltaic assembly and a method for arranging the photovoltaic assembly. The guide rail is used for guiding folding and unfolding movements of photovoltaic panels of a foldable photovoltaic assembly. The guide rail comprises a guide rail body, wherein the top of the guide rail body is provided with a first rail extending in a lengthwise direction of the guide rail body, and a side face of the guide rail body is provided with a second rail extending in the same direction as the first rail. The guide rail can ensure smoother and more stable folding and unfolding movements of the photovoltaic panels, making it unlikely for the moving part to deviate from or fall off the guide rail. It can also enhance the connection strength between the photovoltaic panel assembly and the guide rail, and improve the overall stability of the photovoltaic assembly.

### CROSS REFERENCE TO RELATED APPLICATIONS

The present application claims the benefit of priority of Chinese Application No. 202411996365.4 filed Dec. 31, 2024, the entirety of which is incorporated by reference herein in its entirety.

### TECHNICAL FIELD

The present application relates to the technical field of a photovoltaic device, and in particular to a guide rail, a guide rail assembly, a photovoltaic assembly and a method for arranging the photovoltaic assembly.

### BACKGROUND

Photovoltaic technology is a technology for directly converting light energy into electrical energy through the photovoltaic effect on a semiconductor interface. It primarily relies on photovoltaic modules, such as photovoltaic panels, for solar power generation. Photovoltaic panels are an environmentally friendly device for energy production, as they do not produce environmental pollution during the power generation process.

The known photovoltaic assembly typically comprises a plurality of photovoltaic panels. Before the photovoltaic assembly is used for power generation, each photovoltaic panel commonly needs to be installed and secured at a proper position and inclination angle on the ground or a building, so that the surface of the photovoltaic panel is exposed to sunlight as much as possible, thereby improving power generation efficiency.

It is to be noted that the information disclosed in the Background section is only for the purpose of enhancing understanding of the background of the present disclosure, and thus may include information that does not constitute prior art known to a person skilled in the art.

### SUMMARY

One aspect of the present application is to solve the technical problem of how to realize folding and unfolding of photovoltaic panels of a foldable photovoltaic assembly more easily and precisely.

In addition, other aspects of the present application are further intended to solve or alleviate other technical problems existing in the prior art.

The present application provides a guide rail, a guide rail assembly, a photovoltaic assembly and a method for arranging the photovoltaic assembly. Specifically, according to a first aspect of the present application, there is provided:

A guide rail for guiding folding and unfolding movements of photovoltaic panels of a foldable photovoltaic assembly, comprising a guide rail body, wherein the top of the guide rail body is provided with a first rail extending in a lengthwise direction of the guide rail body, and a side face of the guide rail body is provided with a second rail extending in the same direction as the first rail.

Optionally, according to one embodiment of the present application, the guide rail body comprises a bearing part and a notch provided on the top of the bearing part, and the notch forms the first rail.

Optionally, according to one embodiment of the present application, the notch is provided with a rack.

Optionally, according to one embodiment of the present application, the bearing part is configured as a hollow rectangular frame structure.

Optionally, according to one embodiment of the present application, the guide rail further comprises a base connected to the bottom of the guide rail body and a side wing connected to the side face of the guide rail body, wherein the base and the side wing extend in the lengthwise direction, and the second rail is formed between the base and the side wing.

Optionally, according to one embodiment of the present application, the side wing comprises a first extension part connected with the side face and a first stopper connected with the first extension part, wherein the first stopper protrudes downwards in the height direction of the guide rail body compared with the first extension part.

Optionally, according to one embodiment of the present application, the thickness of the first extension part gradually decreases from the side face to the first stopper.

Optionally, according to one embodiment of the present application, the first extension part is provided with a weight reduction cavity having a triangular cross section.

Optionally, according to one embodiment of the present application, the base comprises a guide rail part connected with the bottom of the guide rail body and a supporting part connected with the guide rail part, wherein the guide rail part comprises a second extension part connected with the bottom and a second stopper connected with the second extension part, and the second stopper protrudes upwards in the height direction of the guide rail body compared with the second extension part.

Optionally, according to one embodiment of the present application, the bottom of the second extension part is provided with a weight reduction notch.

Optionally, according to one embodiment of the present application, two side faces of the guide rail are respectively provided with the base and the side wing, so that a second rail is formed on each of the two side faces of the guide rail.

Optionally, according to one embodiment of the present application, the guide rail body, the base and the side wing are integrally formed, and are all made of aluminum alloy.

Optionally, according to one embodiment of the present application, the supporting part is provided with mounting holes for installation onto a foundation of the photovoltaic assembly.

Optionally, according to one embodiment of the present application, the supporting part is provided with two groups of mounting holes, wherein each group of mounting holes comprises a plurality of uniformly spaced mounting holes, and the two groups of mounting holes are symmetrical with respect to the center of the guide rail.

According to a second aspect of the present application, the present application provides a guide rail assembly, comprising a plurality of the aforementioned guide rails and a fixed connecting piece, wherein two ends of the guide rail body are provided with first through-holes, and two ends of the fixed connecting piece are respectively connected to the first through-holes of adjacent ends of two adjacent guide rails through bolts, to fixedly connect two adjacent guide rails.

Optionally, according to one embodiment of the second aspect of the present application, the guide rail body comprises a bearing part and a notch provided on the top of the bearing part, wherein the notch forms the first rail, and the bearing part is configured as a hollow frame structure;
the guide rail assembly further comprises a connecting pipe, wherein two ends of the connecting pipe are provided with second through-holes, and the two ends of the connecting pipe are respectively inserted into the bearing parts of two adjacent guide rails, ensuring that the positions of the two second through-holes respectively match with those of the first through-holes of two adjacent guide rails, and the connecting pipe is connected with two adjacent guide rails and the fixed connecting piece respectively through the bolts.

According to a third aspect of the present application, the present application provides a photovoltaic assembly, comprising:
a photovoltaic panel assembly, comprising a plurality of photovoltaic panels, a first shaft rod and a second shaft rod, wherein one side of two adjacent photovoltaic panels is hinged to the first shaft rod via a first hinge, and the other side of two adjacent photovoltaic panels is hinged to the second shaft rod via a second hinge, and two ends of the second shaft rod are each connected with a moving part; and
two parallelly arranged guide rail assemblies as mentioned above, with the moving part provided on a first rail of the guide rail and capable of moving along the first rail;
wherein the plurality of photovoltaic panels perform folding and unfolding movements around the first shaft rod and the second shaft rod through the movement of the moving part along the first rail.

Optionally, according to one embodiment of the third aspect of the present application, the first rail is provided with a rack, the moving part is configured as a gear matching with the rack, and the second shaft rod is connected with the gear through a bearing.

Optionally, according to one embodiment of the third aspect of the present application, the photovoltaic panel assembly further comprises a fixing member connected with the guide rail and a motor fixed on the fixing member, and an output shaft of the motor is connected with a gear shaft of the gear.

Optionally, according to one embodiment of the third aspect of the present application, the fixing member is provided with a clamping shaft extended into the second rail, and the clamping shaft is provided with a first rolling element capable of rolling along the second rail.

Optionally, according to one embodiment of the third aspect of the present application, the guide rail further comprises a base connected to the bottom of the guide rail body and a side wing connected to the side face of the guide rail body, wherein the b ase and the side wing extend in the lengthwise direction, and the second rail is formed between the base and the side wing;
the first rolling element comprises a ball bearing and a rolling bearing, wherein the ball bearing rolls in the second rail along the side face, and the rolling bearing rolls in the second rail along the side wing and the surface of the base.

Optionally, according to one embodiment of the third aspect of the present application, two side faces of the guide rail are respectively provided with the base and the side wing, so that a second rail is formed on each of the two side faces of the guide rail;
the second shaft rod is connected with an L-shaped connecting rod, wherein one end of the connecting rod is connected to the second shaft rod, and the other end is extended into the second rail of the guide rail away from the fixing member, and the end of the connecting rod extended into the second rail is connected with a second rolling element capable of rolling in the second rail.

Optionally, according to one embodiment of the third aspect of the present application, the second rolling element is configured as a joint bearing.

Optionally, according to one embodiment of the third aspect of the present application, the end of the connecting rod connected with the second shaft rod is provided with a screw thread, and the connecting rod is screwed to the second shaft rod through the screw thread and protrudes beyond the second shaft rod. The portion of the connecting rod protruding beyond the second shaft is installed with a first wiring board, and the fixing member is installed with a second wiring board opposite to the first wiring board.

According to a fourth aspect of the present application, the present application provides a method for arranging the aforementioned photovoltaic assembly, comprising the following steps:
connecting the guide rails into a guide rail assembly through a connecting pipe and a fixed connecting piece;
mounting the guide rail assembly onto a foundation through mounting holes provided on the guide rail assembly;
mounting the moving part and the L-shaped connecting rod onto a second shaft rod; and
mounting the moving part onto the first rail, and mounting a second rolling element on one end of the connecting rod onto the second rail.

Optionally, according to one embodiment of the fourth aspect of the present application, the method further comprises the following steps:
mounting a first rolling element on a fixing member onto the second rail; and
mounting a motor to the fixing member, and drivingly connecting an output shaft of the motor to the moving part.

The benefits of the present application include:
1. The guide rail set forth in one embodiment of the present application can simplify the folding and unfolding movements of photovoltaic panels, so that the photovoltaic panels can be folded and unfolded through the rolling movement of the gear on the guide rail, thereby reducing the manual labor required for arranging the photovoltaic panels, and improving the efficiency of arranging the photovoltaic panels;
2. The guide rail set forth in one embodiment of the present application not only can enable the photovoltaic panel assembly to be more easily folded and unfolded through the movement between the gear and the first rail of the guide rail, but also can provide additional fixing effect as the guide rail per se has high strength. By combining a moving component on a fixing member with a second rail of the guide rail, the movement between the gear and the guide rail is limited, and the gear is prevented from deviation or falling off during its movement on the guide rail, thereby improving the precision and safety of the folding and unfolding movements of the photovoltaic panels, and enhancing the smoothness of the relative movement between the gear and the guide rail;
3. By connecting an L-shaped connecting piece with the second shaft rod of the photovoltaic assembly and another second rail of the guide rail, stable fixation between the photovoltaic assembly and the guide rail is further achieved, which helps resist interference from external wind forces during the folding and unfolding movements of the photovoltaic panels;
4. The guide rail assembly set forth in one embodiment of the present application implements a detachable, high-strength, easy-to-install, and standardized solution for arranging the guide rails. The guide rails are interconnected through connecting pipes, which enhances the bearing capacity at the joints of the guide rails. The arrangement of the mounting holes on the guide rails ensures precise installation of the guide rails to the foundation, regardless of whether they are installed in the forward or reverse direction;
5. The photovoltaic assembly set forth in one embodiment of the present application can achieve automatic folding and unfolding of the photovoltaic panels by using a motor to drive the movement of the gear on the guide rail, without the need for manual operation by installation personnel. The photovoltaic panel assembly and the guide rail assembly are convenient to install to one another and easy to disassemble from one another.

### BRIEF DESCRIPTION OF THE DRAWINGS

The above-mentioned and other features of the present application will become apparent with reference to the drawings. It is easy for a person skilled in the art to understand that: these drawings are for illustrative purposes only, and are not intended to limit the protection scope of the present application. In addition, similar numerals in the drawings represent similar components. In the drawings,

FIG. 1 shows a schematic view of a photovoltaic assembly according to one embodiment of the present application;

FIG. 2 shows an enlarged view of a photovoltaic assembly at two adjacent photovoltaic panels according to one embodiment of the present application;

FIG. 3 shows a structural schematic view of a guide rail according to one embodiment of the present application;

FIG. 4 shows a schematic view of the joint between two guide rails in a guide rail assembly according to one embodiment of the present application;

FIG. 5 shows an enlarged view of the joint where one guide rail is removed from the two interconnected guide rails according to FIG. 4;

FIG. 6 shows a structural schematic view of a guide rail according to one embodiment of the present application viewed from one side when a photovoltaic assembly is mounted on the guide rail;

FIG. 7 shows an enlarged view of a fixing member according to FIG. 6;

FIG. 8 shows a structural schematic view of a guide rail according to one embodiment of the present application viewed from the other side when a photovoltaic assembly is mounted on the guide rail;

FIG. 9 shows a schematic flowchart of a method for arranging a photovoltaic assembly according to one embodiment of the present application.

### DETAILED DESCRIPTION OF EMBODIMENTS

It is readily appreciated that according to the technical solution of the present application, without changing the essential spirit of the present application, a person skilled in the art can propose a variety of interchangeable structural forms and implementation methods. Therefore, the following specific embodiments and drawings are only exemplary descriptions of the technical solution of the present application, and should not be deemed as the entirety of the present application or as a limitation to or restriction on the technical solution of the present application.

The directional terms such as up, down, left, right, front, back, front side, back side, top, bottom, etc. mentioned in the present specification are defined relative to the structures shown in the drawings. They are relative concepts and thus may change accordingly depending on different positions and states of use thereof. Therefore, these or other directional terms should not be interpreted as restrictive terms. In addition, terms such as “first”, “second”, “third” or similar expressions are used for descriptive and distinguishing purposes only, and are not to be construed as indicating or implying relative importance of corresponding components or sequential order or assembly sequence of components.

In known photovoltaic assemblies, a plurality of photovoltaic panels are typically provided. When photovoltaic power generation is required, a plurality of photovoltaic panels are arranged and installed in a designated area. Conversely, when power generation is not required, the photovoltaic panels can be moved and stored away. In order to simplify the arrangement, installation, movement and storage process of the photovoltaic panels, in some photovoltaic assemblies, the photovoltaic panels are arranged in a foldable form, particularly in an accordion-style foldable form. When not in use, the photovoltaic panels are folded up, and when they are needed for arrangement, a plurality of photovoltaic panels are sequentially unfolded for arrangement. However, the folding and unfolding of the photovoltaic panels are typically performed manually by installation personnel, which not only demands a significant amount of labor but also results in low installation efficiency and installation precision of the photovoltaic panels.

In the first aspect of the present application, a guide rail 100 is provided, which is used to guide the folding and unfolding movements of photovoltaic panels 210 of a foldable photovoltaic assembly. The shaft rod connected to the photovoltaic panels 210 can move along the guide rail 100 via the moving parts 240 on it, thereby making it easier for the photovoltaic panels 210 to fold or unfold in an accordion manner. This reduces the manual effort required when arranging the photovoltaic panels 210 and also improves the installation efficiency and accuracy of the photovoltaic panels 210.

In order to describe the structure of the guide rail and the function thereof more clearly and specifically, firstly, the photovoltaic assembly 1 set forth in a third aspect of the present application and the function realized by the guide rail 100 in the photovoltaic assembly 1 are briefly described hereinafter.

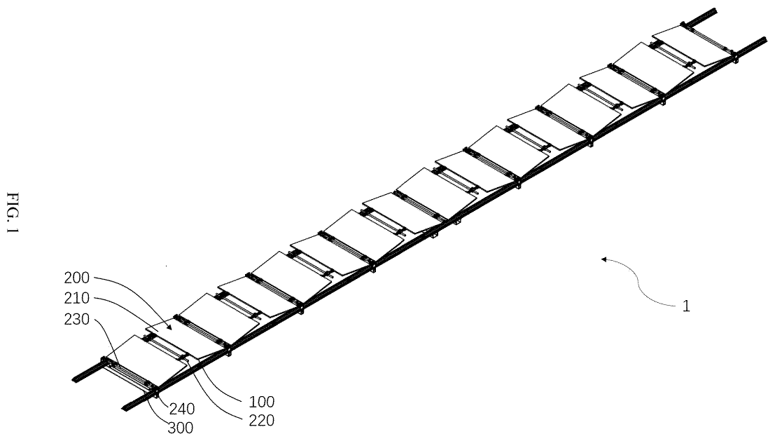

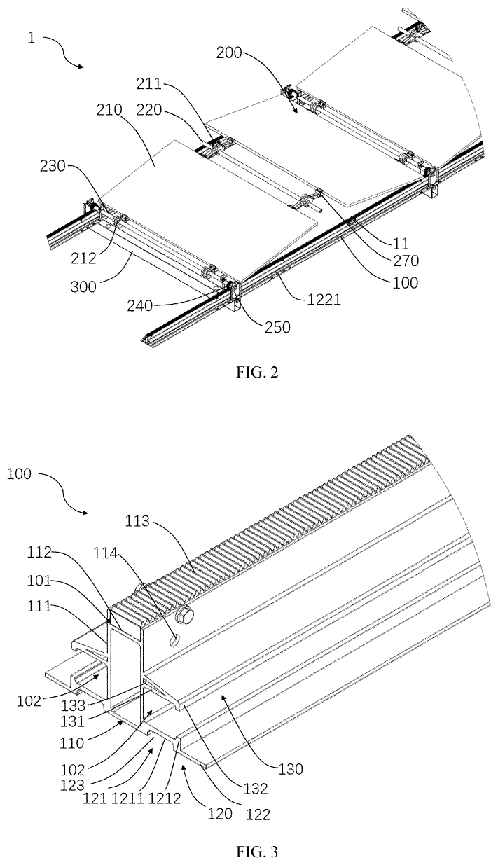

Referring to FIG. 1 and FIG. 2, these figures respectively show a schematic view of a photovoltaic assembly 1 and an enlarged view of a photovoltaic assembly 1 at two adjacent photovoltaic panels 210 according to one embodiment of the present application. The photovoltaic assembly 1 set forth in one embodiment of the third aspect of the invention comprises a photovoltaic panel assembly 200 and a guide rail 100, wherein the photovoltaic panel assembly 200 is movably connected with the guide rail 100. The photovoltaic panel assembly 200 comprises a plurality of photovoltaic panels 210, a first shaft rod 220 and a second shaft rod 230, wherein one side of two adjacent photovoltaic panels 210 is hinged to the first shaft rod 220, and the other side is hinged to the second shaft 230. As such, each photovoltaic panel 210 can rotate around the first shaft rod 220 and the second shaft rod 230, to realize the relative folding or unfolding movement between adjacent photovoltaic panels 210. Each of the two ends of the second shaft rod 230 is connected with a moving part 240 which is provided on the guide rail 100 and can move along the guide rail 100. As can be seen from FIG. 2, when the moving part 240 is moving on the guide rail 100, the linear distance between adjacent second shaft rods 230 also correspondingly increases or decreases. Then, the photovoltaic panels 210 rotate around the first shaft rod 220 and the second shaft rod 230 at the same time, thereby realizing the folding and unfolding movements between adjacent photovoltaic panels 210.

It can be seen from FIG. 1 and FIG. 2 that the movement of two ends of the second shaft rod 230 on two guide rails 100 is achieved by connecting the moving part 240 on the second shaft rod 230 of the photovoltaic panel assembly 200 with the guide rail 100, thereby realizing the folding and unfolding movements between adjacent photovoltaic panels 210. The first aspect of the present application proposes a guide rail 100 having this function. Referring to FIG. 3, it shows a structural schematic view of a guide rail 100 according to one embodiment of the present application. The guide rail 100 comprises a guide rail body 110, wherein the top of the guide rail body 110 is provided with a first rail 101 extending in a lengthwise direction of the guide rail body 110, and a side face of the guide rail body 110 is provided with a second rail 102 extending in the same direction as the first rail 101.

According to the above explanation of the function of the guide rail 100 in the photovoltaic assembly 1, it can be seen that the first rail 101 of the guide rail 100 is used for the movement of the moving part 240 on the second shaft rod 230. Apart from the first rail 101, the guide rail 100 is further provided with a second rail 102 extending in the same direction as the first rail 101. The second rail 102 is used to connect with other connecting piece or a moving component on a fixing member in the photovoltaic assembly 1. The moving part 240 in the first rail 101 moves synchronously with the moving component in the second rail 102, for positioning and limiting the movement of the moving part 240 of the second shaft rod 230. In the following description of the specific structure of the photovoltaic assembly 1, the function of the second rail 102 applied to the photovoltaic assembly 1 will be described in detail.

In one embodiment of the present application, the guide rail body 110 comprises a bearing part 111 and a notch 112 provided on the top of the bearing part 111. The notch 112 forms the aforementioned first rail 101. The bearing part 111 of the guide rail body 110 can improve the strength of the guide rail body 110. The assembly formed by the photovoltaic panels 210, as a whole, moves via the moving part 240 in the first rail 101. Thus, the guide rail body 110 bears a relatively heavy weight on the first rail 101. With the bearing part 111 disposed under the first rail 101, this helps improve the bearing capacity of the guide rail 100, and prevent deformation of the guide rail 100. Furthermore, the bearing part 111 is configured as a hollow rectangular frame structure, and the bearing part 111 is particularly made of aluminum alloy, which further improves the strength of the bearing part 111 per se.

In one embodiment of the present application, the notch 112 is provided with a rack 113. In this embodiment, the moving part 240 connected to the second shaft rod 230 is configured as a gear matching with the rack 113. Then, the relative movement between the moving part 240 and the first rail 101 is rolling movement. The rack 113 is connected to the notch 112, for example, by bolts, in which case the side walls of the notch 112 are provided with through-holes for the bolts. The rack 113 may also be welded into the notch 112. In some embodiments, when the rack 113 is disposed in the notch 112, there is a gap provided between the rack 113 and the side walls of the notch 112, and the gap is filled with a foam part, through which the rack 113 is fixed in the notch 112. It should be understood that a person skilled in the art may also use any other fixing means to secure the rack 113 in the notch 112.

It should be understood that the rack 113 may also not be provided in the notch 112, and the moving part 240 may be configured as, for example, a pulley or a sliding block, which directly rolls or slides along the surface of the notch 112. A person skilled in the art may also use any other form of configuration that can realize the relative movement between the moving part and the first rail 101, which should also be included within the protection scope of the present application.

In one embodiment of the present application, the guide rail 100 further comprises a base 120 connected to the bottom of the guide rail body 110 and a side wing 130 connected to a side face of the guide rail body 110, wherein the base 120 and the side wing 130 protrude outwards from the guide rail body 110 in the direction perpendicular to the lengthwise direction of the guide rail 100, and the base 120 and the side wing 130 also extend in the lengthwise direction, forming a second rail 102 between the base 120 and the side wing 130. During the installation of the photovoltaic assembly 1, the guide rail 100 per se needs to be placed in an installation area or installed on a foundation 300. Thus, providing a base 120 connected to the bottom of the guide rail body 110 on the guide rail 100 helps expand the area of the bottom of the guide rail, and increase fixation stability. Where the base 120 is provided, it is only necessary to arrange a side wing 130 protruding outwards on a side face of the guide rail body 110 so that a second rail 102 is formed between the side wing 130 and the base 120, without additionally arranging two rail walls on the side face for enclosure to form a second rail 102. This further simplifies the structure of the guide rail 100 per se.

In one embodiment of the present application, two side faces of the guide rail 100 are respectively provided with the base 120 and the side wing 130 (especially the base 120 and the side wing 130 of the same structure, which are preferably symmetrical with respect to the guide rail body 110), so that a second rail 102 is formed on each of the two side faces of the guide rail 100. Such means of configuration enables each of the two side faces of the guide rail 100 to be provided with a connecting piece or fixing member connected to the second rail 102, which simultaneously achieves the effect of limiting the movement of the moving part 240 relative to the first rail 101. This embodiment will be further explained in detail when describing the specific structure of the photovoltaic assembly 1.

In one embodiment of the present application, the side wing 130 comprises a first extension part 131 connected with the side face of the guide rail body 110 and a first stopper 132 connected with the first extension part 131, wherein the first stopper 132 protrudes downwards in the height direction of the guide rail body 110 compared with the first extension part 131. As can be seen from FIG. 3, the first extension part 131 of the side wing 130 forms the upper surface of the second guide rail 102, and the first stopper 132 can be used for preventing the moving component in the second rail 102 from being disengaged from the second rail 102. Further, the thickness of the first extension part 131 gradually decreases from the side surface to the first stopper 132. Such means of configuration of the first extension 131 is to improve the strength of the side wing 130. Since the photovoltaic assembly 200 is supported on the first rail 101 through the moving part 240, most of the gravity of the photovoltaic panel assembly 200 is borne by the first rail 101 and the bearing part 111. Thus, when the moving component moves in the second rail 102, the load that it exerts on the base 120 is generally smaller than the load that it exerts on the side wing 130, and increasing the thickness of the side wing 130 as appropriate can prevent the side wing 130 from being deformed by the load from the moving component. In addition, in order to reduce the overall mass of the guide rail 100 while increasing the thickness of the side wing 130 as appropriate, the side wing 130 is configured to have a thickness that gradually decreases from the side face to the first stopper 132. In order to further reduce the weight of the side wing 130, in some embodiments, the first extension part 131 is provided with a weight reduction cavity 133, especially a weight reduction cavity 133 having a triangular cross section. Such weight reduction cavity 133 can achieve weight reduction while ensuring that the thickness of the side wing 130 gradually decreases from the side surface to the first stopper 131 or at least ensure that the thickness of the inner side of the side wing 130 is no less than the thickness of the outer side, thereby not reducing the strength of the side wing 130 as much as possible or only reducing it in a small degree.

In one embodiment of the present application, the base 120 comprises a guide rail part 121 connected with the bottom of the guide rail body 110 and a supporting part 122 connected with the guide rail part 121, wherein the guide rail part 121 comprises a second extension part 1211 connected with the bottom and a second stopper 1212 connected with the second extension part 1211, and the second stopper 1212 protrudes upwards in the height direction of the guide rail body 110 compared with the second extension part 1211. The guide rail part 121 of the base 120 has substantially the same structure as the side wing 130, and the second extension part 1211 and the first extension part 131 of the side wing 130 enclose to form a second rail 102, and the second stopper 1212 is also used for preventing the moving component from being disengaged from the second rail 102. Further, the outer side of the second stopper 1212 is provided with a supporting part 122 which can expand the contact area between the bottom of the guide rail and a fixed area or the foundation 300, thereby improving the fixing effect of the guide rail 100. Similar to the side wing 130, in order to reduce the overall weight of the guide rail 100, the bottom of the second extension part 1211 is provided with a weight reduction notch 123, in particular an arched weight reduction notch 123.

In one embodiment of the present application, the guide rail body 110, the base 120 and the side wing 130 are integrally formed and are all made of aluminum alloy, which helps simplify the overall manufacturing of the guide rail and improve the overall strength of the guide rail as well. It should be understood that a person skilled in the art can manufacture the guide rail 100 using other means or materials, provided that the function of the guide rail 100 is satisfied, according to requirements of different photovoltaic assemblies. This should also be included within the protection scope of the present application.

In one embodiment of the present application, the supporting part 122 of the guide rail base 120 is provided with mounting holes 1221 for installation onto a foundation 300 of the photovoltaic assembly 1. The guide rail 100 at this time is not directly placed on the ground, but is connected to the foundation 300 on the ground via mounting holes 1221, in particular bolts. The foundation 300 is particularly configured as a hollow square tube perpendicular to the lengthwise direction of the guide rail 100, with paired mounting holes provided thereon. The arrangement of the foundation 300 positions the guide rail 100 a certain distance away from the ground, which helps prevent erosion of the guide rail 100 by external environmental factors, in particular safeguarding against interference with the movement in the first rail 101 and the second rail 102, for example, preventing water, dust and the like from entering into the first rail 101 and the second rail 102 to interfere with the movement of the moving part 240 and the moving component.

In one embodiment of the present application, the supporting part 122 is provided with two groups of mounting holes 1221, wherein each group of mounting holes comprises a plurality of uniformly spaced mounting holes 1221, and the two groups of mounting holes are symmetrical with respect to the center of the guide rail. Such means of arranging the mounting holes 1221 is beneficial for situations where multiple guide rails 100 need to be assembled into a guide rail assembly 10 of the photovoltaic assembly 1, particularly accommodating to scenarios where a different number of foundations 300 are used. For example, a different number of foundations or foundations that are spaced differently from each other can be set up according to terrain and environmental factors. The configuration of multiple mounting holes 1221 allows the guide rail 100 to flexibly match a different number of foundations 300 or foundations 300 that are spaced differently from each other. In addition, the symmetrical design of the two groups of mounting holes 1221 with respect to the center of the guide rail eliminates the need to consider the left or right orientation of two ends of the guide rail 100 during installation, which helps improve the installation efficiency of the guide rail 100.

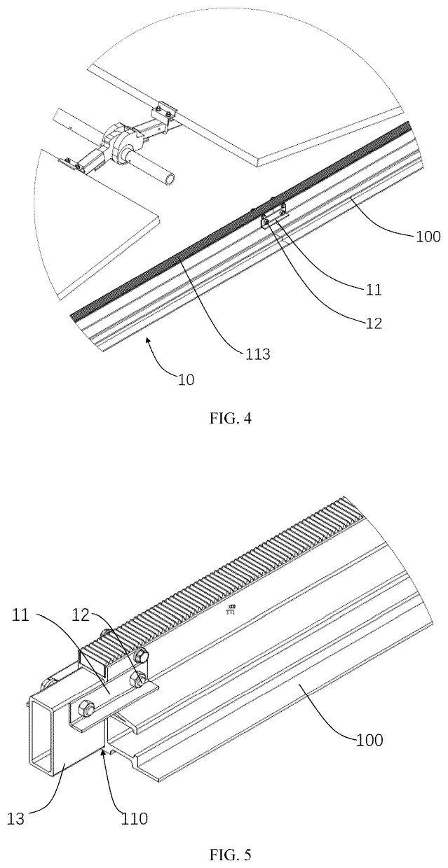

In the second aspect of the present application, a guide rail assembly 10 is provided. Referring to FIG. 4, it shows a schematic view of the joint between two guide rails 100 in a guide rail assembly 10 according to one embodiment of the present application. The guide rail assembly 10 comprises a plurality of the aforementioned guide rails 100 and a fixed connecting piece 11. In the embodiment of FIG. 4, the connecting piece 11 is configured, for example, as an angle steel. Two ends of the guide rail body 110 of each guide rail 100 are provided with first through-holes 114, and two ends of the fixed connecting piece 11 are also provided with corresponding through-holes, so that both ends of the fixed connecting piece 11 can be respectively connected to the first through-holes 114 of adjacent ends of two adjacent guide rails 100 through bolts 12, to fixedly connect two adjacent guide rails 100.

Since the photovoltaic assembly 1 typically comprises a plurality of photovoltaic panels 210, and the size of the photovoltaic panels 210 is relatively large, the overall length of the rail for extending the photovoltaic panels 210 is also generally quite long. If the guide rail of the photovoltaic assembly 1 is integrally configured in the form of a guide rail assembly 10 formed by installing a plurality of guide rails 100, each guide rail 100 can be configured to have a relatively small length, which is convenient for manufacturing, movement and installation of the guide rail 100. Furthermore, the guide rail 100 may also be configured in the form of a standard part, which is suitable for the photovoltaic assembly 1 having a different number of photovoltaic panels 210, thereby realizing more flexible application of a single guide rail 100.

In one embodiment of the present application, the guide rail assembly 10 further comprises a connecting pipe 13. Referring to FIG. 5, it shows an enlarged view of the joint where one guide rail is removed from the two interconnected guide rails according to FIG. 4. Two ends of the connecting pipe 13 are each provided with a second through-hole, and the two ends of the connecting pipe 13 are respectively inserted into the bearing parts 111 of two adjacent guide rails 100, ensuring that the positions of two second through-holes align with the first through-holes 114 of two adjacent guide rails 100, and the connecting pipe 13 is connected with the two adjacent guide rails 100 and the fixed connecting piece 11 through the bolts 12 respectively. The connecting pipe 13 is particularly configured to be installed into the bearing part 111 in a manner matching the shape of the bearing part 111 of a hollow structure.

The moving part 240 will move past each position of the guide rail assembly 10, thereby applying a load from the gravity of the photovoltaic panel 210 to each position of the guide rail 100 during movement. As the guide rail assembly 10 is formed by connecting a plurality of guide rails 100, the bearing capacity of the joint between two adjacent guide rails 100 is generally weaker than that of the other parts of the guide rail assembly 10. By adding the connecting pipe 13, additional support can be provided at the joint of two adjacent guide rails 100 through the connecting pipe 13 disposed within the bearing part 111. This enhances the strength of the guide rail assembly 10, particularly the strength at the joint of two adjacent guide rails 100, ensuring that the joint of two adjacent guide rails 100 does not deform or misalign due to the weight of the photovoltaic assembly 1, so that the movement of the moving part 240 along the guide rail 100 would not be affected.

In the third aspect of the present application, a photovoltaic assembly 1 is provided. The structure of the photovoltaic assembly 1 in one embodiment of the present application may refer to FIGS. 1 and 2 again. The photovoltaic assembly 1 comprises a photovoltaic panel assembly 200 and the aforementioned guide rails 100 or guide rail assembly 10, particularly two guide rails 100 or two guide rail assemblies 10 arranged in parallel. The photovoltaic panel assembly 200 comprises a plurality of photovoltaic panels 210, a first shaft rod 220 and a second shaft rod 230. One side of two adjacent photovoltaic panels 210 is hinged to the first shaft rod 220 via a first hinge 211, and the other side of two adjacent photovoltaic panels 210 is hinged to the second shaft rod 230 via a second hinge 212. Two ends of the second shaft rod 230 are each connected with a moving part 240, and two moving parts 240 are respectively provided on two guide rails 100 or guide rail assemblies 10, in particular on the first rail 101.

Referring to FIG. 2, the photovoltaic panel 210 in the embodiment of FIG. 2 is, for example, first connected to two parallel support rods 270, and then hinged to a first shaft rod 220 arranged perpendicular to the support rods 270 via a first hinge 211 connected to one end of the two support rods 270, and hinged to a second shaft rod 230 arranged perpendicular to the support rods 270 via a second hinge 212 on the other end of the two support rods 270. The first shaft rod 220 merely serves the function of connection and rotation, and is not connected to the guide rail 100 or the guide rail assembly 10. A plurality of photovoltaic panels 210 perform folding and unfolding movements around the first shaft rod 220 and the second shaft rod 230 through the movement of the moving part 240 along the first rail 101.

In the embodiment of FIG. 2, the first hinge 211 comprises two hinges which can be the same or different in structure, and the second hinge 212 also comprises two hinges which can be the same or different in structure. It can be appreciated by a person skilled in the art that under the circumstances where the hinges can realize connection and relative rotation of the photovoltaic panels 210 or the support rods 270 and the shaft rods 220 and 230, hinges with any different structures and any different number of hinges may be selected to realize the connection between the photovoltaic panels 210 or the supporting rods 270 and the shaft rods 220 and 230, which should all be included within the protection scope of the present application.

It should be understood that, in addition to the embodiment of FIG. 2, the photovoltaic panel 210 may also be connected to the first shaft rod 220 and the second shaft rod 230 by other means, for example, the edges of the photovoltaic panel being directly connected to the first shaft rod 220 and the second shaft rod 230 via the hinges, or first being connected with the hinges using other intermediate elements (such as the aforementioned support rods 270) and then connected to the first shaft rod 220 and the second shaft rod 230 via the hinges. These means of connection should all be included within the protection scope of the present application.

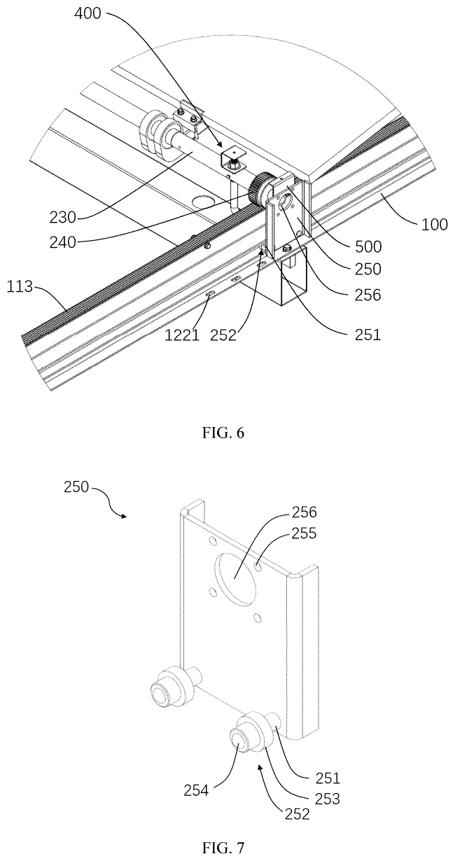

In one embodiment of the present application, the first rail 101 is provided with a rack 113, and the moving part 240 is configured as a gear matching with the rack 113. Referring to FIG. 6, it shows a structural schematic view of a guide rail 100 according to one embodiment of the present application viewed from one side when a photovoltaic panel assembly 200 is mounted on the guide rail 100. In this embodiment, in order to improve motion flexibility of the moving part 240 in the first rail 101, the first rail 101 is provided with a rack 113, and the moving part 240 is configured as a gear matching with the rack 113. The rolling movement of the gear on the rack 113 drives the linear movement of the second shaft rod 230 in the lengthwise direction of the first rail 101. Further, the gear and the second shaft rod 230 are interconnected in particular by a bearing 241 (illustrated in FIG. 8). In other words, the gear and the second shaft rod 230 can rotate relative to each other. Therefore, when the gear rolls on the rack 113, the second shaft rod 230 per se does not need to rotate, but only needs to move linearly in the lengthwise direction of the first rail 101. This further improves the motion flexibility of the moving part 240.

It should be understood that the motion coordination between the first rail 101 and the moving part 240 can also be configured in other forms. For example, the moving part 240 can be configured as a slide block capable of sliding in the first rail 101, in which case the first rail 101 does not need to be provided with a rack 113. The first rail 101 and the moving part 240 may further utilize other forms of coordination such as belt transmission or chain transmission. A person skilled in the art can change the structural form of the moving part 240 and/or the first rail 101 according to different forms of coordination. These should also be included within the protection scope of the present application.

In one embodiment of the present application, the photovoltaic panel assembly 200 further comprises a fixing member 250 connected with the guide rail 100 and a motor (not illustrated in the drawings) fixed on the fixing member 250. The main body of the fixing member 250 is configured in the shape of a plate, and the motor is fixed on the fixing member 250 via motor mounting holes 255 on the fixing member 250. An output shaft of the motor is connected with a gear shaft of the gear through a through-hole 256 in the fixing member 250, so that the motor can provide power for rotating the gear on the rack 113. In this way, the rolling of the gear on the rack 113 can be automatically carried out with the power provided by the motor, without the need to manually drive the gear to roll by installation personnel. It can be appreciated by a person skilled in the art that in addition to the motor, other power sources can be utilized to automatically drive the gear.

In one embodiment of the present application, the fixing member 250 not only serves the function of securing the motor, but also acts to limit the movement of the gear. The fixing member 250 is provided with a clamping shaft 251 extended into the second rail 102, and the clamping shaft 251 is provided with a first rolling element 252 capable of rolling along the second rail 102. When the gear rolls on the rack 113, the first rolling element 252 synchronously rolls in the second rail 102, so that the fixing member 250 remains in a position relative to the gear, limiting the movement path of the gear to the rack 113, and preventing the gear from deviating from the rack 113 during movement. The first stopper 131 and the second stopper 1212 respectively arranged on the side wing 130 and the base 120 ensure that the first rolling element 252 remains in the second rail 102 during movement, and further ensure that the fixing member 250 remains in the same position relative to the gear, and the gear consistently remains in the same position along its axial direction.

In one embodiment of the present application, the first rolling element 252 comprises a ball bearing 253 and a rolling bearing 254 arranged sequentially along the axial direction of the clamping shaft 251. The ball bearing 253 rolls along the side face of the guide rail body 110 in the second rail 102, while the rolling bearing 254 rolls along the surface of the side wing 130 and the base 120 in the second rail 102. Among them, the ball bearing 253, which rolls on the side face of the guide rail body 110 all the time, ensures that the fixing member 250 is positioned in the direction perpendicular to the lengthwise direction of the guide rail 100, namely the axial direction of the second shaft rod 230 or the gear; the rolling bearing 254, which rolls along the surface of the side wing 130 and the base 120 all the time, ensures the positioning of the fixing member 250 in the height direction of the guide rail 100. By ensuring the positioning of the fixing member 250 in these two directions, the positioning of the gear in its axial direction and the height direction of the guide rail 100 is further limited, so that the gear can consistently maintain its position and roll precisely on the rack 113 without any deviation from its movement path.

Referring to FIG. 7, it shows an enlarged view of a fixing member 250 according to FIG. 6. In the embodiment of FIG. 7, the number of clamping shafts 251 is two. The clamping shafts are spaced apart along the lengthwise direction of the guide rail 100, and each clamping shaft 251 is provided with a ball bearing 253 and a rolling bearing 254. This further improves motion stability of the moving part 250, thereby better restricting the position of the gear in its axial direction. It should be understood that the number of clamping shafts 251 may also be one or more than two, and a single clamping shaft 251 may be provided with only one ball bearing 253, or only one rolling bearing 254, or more than one rolling bearing 254, as long as all the clamping shafts 251 collectively comprise at least one ball bearing 253 and at least one rolling bearing 254. These embodiments involving the clamping shafts 251 and the ball bearing 253 and the rolling bearing 254 thereon should all be included within the protection scope of the present application.

In one embodiment of the present application, the second shaft rod 230 and the guide rail 100 may also be connected by a connecting rod 260. Referring to FIG. 8, it shows a structural schematic view of a guide rail 100 according to one embodiment of the present application viewed from the other side when a photovoltaic panel assembly 200 is mounted on the guide rail 100. In this embodiment, the connecting rod 260 is configured as an L-shaped connecting rod 260, wherein one end 261 of the connecting rod is connected to the second shaft rod 230, and the other end 262 is extended into a second rail 102 of the guide rail 100 away from the fixing member 250 and connected with a second rolling element 263 thereon which is capable of rolling in the second rail 102. The second rolling element 263 moves in a way similar to the first rolling element 252, i.e. it also rolls in the second rail 102 synchronously with the gear on the rack 113. Since the connecting rod 260 has one end 262 connected to the second rolling element 263 and the other end 261 connected to the second shaft rod 230, its independence from the fixing member 250 directly increases the connecting strength between the second shaft rod 230 and the guide rail 100, and further limits the movement of the gear on the rack 113 from the inner side of the guide rail 100. On the one hand, this prevents the second shaft rod 230 from disengagement and deviation during movement, especially if there is a relatively strong wind in the surrounding environment. On the other hand, this further prevents the gear movement from deviation or disengagement from the rack 113. Furthermore, the second rolling element 263 is configured as a joint bearing, so that the connecting rod 260 has a higher degree of freedom at the second rolling element 264 and can freely deviate in all directions. In this way, under the circumstances where the second rolling element 263 is consistently connected into the second rail 102, the L-shaped connecting rod 260 does not need to be kept in a vertical position all the time, and may have a certain inclination, which leaves a certain space of movement for the L-shaped connecting rod 260, and prevents deformation caused by an excessive load borne by the connecting rod 260 when external wind forces are too strong.

In one embodiment of the present application, the end of the connecting rod 260 connected with the second shaft rod 230 is provided with a screw thread, and the second shaft 230 is provided with a threaded hole. The connecting rod 260 is screwed to the second shaft rod 230 through the screw thread and protrudes beyond the second shaft rod 230. The portion of the connecting rod 260 that protrudes beyond the second shaft rod 230 is installed with a first wiring board 400. The first wiring board 400 is particularly installed at the end 261 of the connecting rod 260 which is provided with a screw thread, through a through-hole thereon and a nut. The fixing member 250 is installed with a second wiring board 500 opposite to the first wiring board 400. The first wiring board 400 and the second wiring board 500 particularly comprise vertical plates 410, 510 and horizontal plates 420, 520 connected to each other at right angles, respectively. The vertical plates 410, 510 are arranged in the height direction of the guide rail 100, and the horizontal plates 420, 520 are preferably higher than the gear in the height direction of the guide rail 100. The horizontal plates 420, 520 of the first wiring board 400 and the second wiring board 500 are, for example, provided with wiring holes 421, 521 for wires to go through. With the arrangement of the first wiring board 400 and the second wiring board 500, the wiring harnesses for the photovoltaic panel 210 and the motor can be better arranged to bypass the gear and the rack 113. This prevents the wiring harnesses from becoming entangled with the gear or the rack 113, or from wrapping around the second shaft rod 230 as the gear rolls on the rack 113.

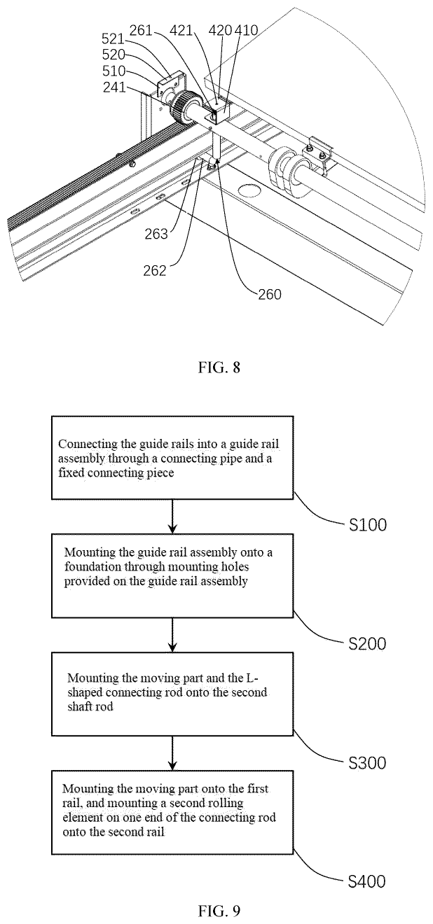

In the fourth aspect of the present application, a method for arranging the aforementioned photovoltaic assembly 1 is further provided. Referring to FIG. 9, it shows a schematic flowchart of a method for arranging a photovoltaic assembly 1 according to one embodiment of the present application, wherein S100-S400 represent each step of the method respectively. The method comprises the following steps:
S100: connecting the guide rails 100 into a guide rail assembly 10 through a connecting pipe 13 and a fixed connecting piece 11;
S200: mounting the guide rail assembly 10 onto a foundation 300 through mounting holes 1221 provided on the guide rail assembly 10;
S300: mounting the moving part 240 and the L-shaped connecting rod 260 onto the second shaft rod 230; and
S400: mounting the moving part 240 onto the first rail 101, and mounting a second rolling element 263 on one end of the connecting rod 260 onto the second rail 102.

In this embodiment, firstly, the guide rail assembly 10 is assembled, and in order to avoid interference of external environmental factors such as dust, rainwater and the like when the guide rail assembly 10 is directly arranged on the ground, the guide rail assembly 10 is mounted on the foundation 300. The foundation 300, rather than the guide rail assembly 10, is arranged on the ground. For example, the guide rail 100 is connected with the foundation 300 by bolts.

The second shaft rod 230 is connected to the guide rail 100 after it is assembled with the moving part 240 and the connecting rod 260. As the moving part 240 moves almost synchronously with second rolling element 263 on the guide rail 100, it is also possible to install the moving part 240 on the first rail 101 and install the second rolling element 263 on the second rail 102 at the same time during installation, to improve installation efficiency.

In one embodiment of the present application, the method further comprises the following steps:
mounting a first rolling element 252 on a fixing member 250 to another second rail 102; and
mounting a motor to the fixing member 250, and drivingly connecting an output shaft of the motor to the moving part 240.

The fixing member 250 is installed after the installation of the second shaft rod 230 and the gear, for the convenience of alignment with the gear shaft. During the installation of the fixing member 250, firstly, the first rolling element 252 is mounted to another second rail 102, that is, the second rail 102 not installed with the second rolling element 263. The fixing member 250 is moved in place by the rolling movement of the first rolling element 252 in the second rail 102, especially aligning the through-hole 256 on the fixing member 250 with the gear shaft. Finally, the motor is installed, and the output shaft of the motor is drivingly connected to the moving part 240.

In conclusion, the guide rail 100, the guide rail assembly 10 and the photovoltaic assembly 1 set forth in one embodiment of the present application can provide foldable photovoltaic panels with a means of folding and unfolding movements that features convenient installation, smooth movement, and high precision in movement. This ensures that the folding and unfolding of the photovoltaic panels is smoother, and the moving part 240 is not likely to deviate from or fall off the guide rail. This can also enhance the connection strength between the shaft rod of the photovoltaic panel 210 and the guide rail 100, achieving stable fixation during the arrangement and installation of the photovoltaic panels 210.

It should be understood that all the preferred embodiments mentioned above are exemplary rather than restrictive, and various modifications or variations made by a person skilled in the art to the specific embodiments described above, within the conception of the present application, should all be included within the legal protection scope of the present application.

1. A guide rail for guiding folding and unfolding movements of photovoltaic panels of a foldable photovoltaic assembly, comprising a guide rail body, wherein the top of the guide rail body is provided with a first rail extending in a lengthwise direction of the guide rail body and a side face of the guide rail body is provided with a second rail extending in the same direction as the first rail.

2. The guide rail according to claim 1, wherein the guide rail body comprises a bearing part and a notch provided on the top of the bearing part, and the notch forms the first rail.

3. The guide rail according to claim 2, wherein the notch is provided with a rack.

4. The guide rail according to claim 2, wherein the bearing part is configured as a hollow rectangular frame structure.

5. The guide rail according to claim 1, wherein the guide rail further comprises a base connected to the bottom of the guide rail body and a side wing connected to the side face of the guide rail body, wherein the base and the side wing extend in the lengthwise direction, and the second rail is formed between the base and the side wing.

6. The guide rail according to claim 5, wherein the side wing comprises a first extension part connected with the side face and a first stopper connected with the first extension part, wherein the first stopper protrudes downwards in the height direction of the guide rail body compared with the first extension part.

7. The guide rail according to claim 6, wherein the thickness of the first extension part gradually decreases from the side face to the first stopper.

8. The guide rail according to claim 7, wherein the first extension part is provided with a weight reduction cavity having a triangular cross section.

9. The guide rail according to claim 5, wherein the base comprises a guide rail part connected with the bottom of the guide rail body and a supporting part connected with the guide rail part, wherein the guide rail part comprises a second extension part connected with the bottom and a second stopper connected with the second extension part, and the second stopper protrudes upwards in the height direction of the guide rail body compared with the second extension part.

10. The guide rail according to claim 9, wherein the bottom of the second extension part is provided with a weight reduction notch.

11. The guide rail according to claim 5, wherein two side faces of the guide rail are respectively provided with the base and the side wing, so that a second rail is formed on each of the two side faces of the guide rail.

12. The guide rail according to claim 5, wherein the guide rail body, the base and the side wing are integrally formed, and are all made of aluminum alloy.

13. The guide rail according to claim 9, wherein the supporting part is provided with mounting holes for installation onto a foundation of the photovoltaic assembly.

14. The guide rail according to claim 13, wherein the supporting part is provided with two groups of mounting holes, wherein each group of mounting holes comprises a plurality of uniformly spaced mounting holes, and the two groups of mounting holes are symmetrical with respect to the center of the guide rail.

15. A guide rail assembly, comprising a plurality of the guide rails according to claim 1 and a fixed connecting piece, wherein two ends of the guide rail body are provided with first through-holes, and two ends of the fixed connecting piece are respectively connected to the first through-holes of adjacent ends of two adjacent guide rails through bolts, to fixedly connect two adjacent guide rails.

16. The guide rail assembly according to claim 15, wherein the guide rail body comprises a bearing part and a notch provided on the top of the bearing part, wherein the notch forms the first rail, and the bearing part is configured as a hollow frame structure;
the guide rail assembly further comprises a connecting pipe, wherein two ends of the connecting pipe are provided with second through-holes, and the two ends of the connecting pipe are respectively inserted into the bearing parts of two adjacent guide rails, ensuring that the positions of the two second through-holes respectively match with those of the first through-holes of two adjacent guide rails, and the connecting pipe is connected with two adjacent guide rails and the fixed connecting piece respectively through the bolts.

17. A photovoltaic assembly, comprising:
a photovoltaic panel assembly, comprising a plurality of photovoltaic panels, a first shaft rod and a second shaft rod, wherein one side of two adjacent photovoltaic panels is hinged to the first shaft rod via a first hinge, and the other side of two adjacent photovoltaic panels is hinged to the second shaft rod via a second hinge, and two ends of the second shaft rod are each connected with a moving part; and
two parallelly arranged guide rail assemblies according to claim 15, with the moving part provided on a first rail of the guide rail and capable of moving along the first rail;
wherein the plurality of photovoltaic panels perform folding and unfolding movements around the first shaft rod and the second shaft rod through the movement of the moving part along the first rail.

18. The photovoltaic assembly according to claim 17, wherein the first rail is provided with a rack, the moving part is configured as a gear matching with the rack, and the second shaft rod is connected with the gear through a bearing.

19. The photovoltaic assembly according to claim 18, wherein the photovoltaic panel assembly further comprises a fixing member connected with the guide rail and a motor fixed on the fixing member, and an output shaft of the motor is connected with a gear shaft of the gear.

20. The photovoltaic assembly according to claim 19, wherein the fixing member is provided with a clamping shaft extended into the second rail, and the clamping shaft is provided with a first rolling element capable of rolling along the second rail.

21. The photovoltaic assembly according to claim 20, wherein the guide rail further comprises a base connected to the bottom of the guide rail body and a side wing connected to the side face of the guide rail body, wherein the base and the side wing extend in the lengthwise direction, and the second rail is formed between the base and the side wing;
the first rolling element comprises a ball bearing and a rolling bearing, wherein the ball bearing rolls in the second rail along the side face, and the rolling bearing rolls in the second rail along the side wing and the surface of the base.

22. The photovoltaic assembly according to claim 21, wherein two side faces of the guide rail are respectively provided with the base and the side wing, so that a second rail is formed on each of the two side faces of the guide rail;
the second shaft rod is connected with an L-shaped connecting rod, wherein one end of the connecting rod is connected to the second shaft rod and the other end is extended into the second rail of the guide rail away from the fixing member, and the end of the connecting rod extended into the second rail is connected with a second rolling element capable of rolling in the second rail.

23. The photovoltaic assembly according to claim 22, wherein the second rolling element is configured as a joint bearing.

24. The photovoltaic assembly according to claim 22, wherein the end of the connecting rod connected with the second shaft rod is provided with a screw thread, and the connecting rod is screwed to the second shaft rod through the screw thread and protrudes beyond the second shaft rod, wherein the portion of the connecting rod protruding beyond the second shaft is installed with a first wiring board, and the fixing member is installed with a second wiring board opposite to the first wiring board.

25-26. (canceled)
